(19) United States
(12) Patent Application Publication
(10) Pub. No.: US 2011/0057929 A1
(43) Pub. Date: Mar. 10, 2011

(54) MODEL DRIVEN 3D GEOMETRIC MODELING SYSTEM

(75) Inventors: Henry Chen, Beijing (CN); Chengjun Li, Beijing (CN); tom Plocher, Hugo, MN (US); Conrad Bruce Beaulieu, Duluth, MN (US)

(73) Assignee: Honeywell International Inc

(21) Appl. No.: 12/920,434

(22) PCT Filed: Mar. 3, 2008
(86) PCT No.: PCT/CN08/00420

§ 371 Date: Nov. 23, 2010

(51) Int. Cl. G06T 15/00

(52) U.S. Cl. 345/419

(57) ABSTRACT

A method and system of generating a 3D geometric object model for a domain. The method includes: extracting basic geometric elements from an input source; converting the basic geometric elements into domain elements according to a domain model, wherein the domain elements preserve semantic information of their attributes and relationships defined by the domain model; and constructing a 3D geometric model, including 3D geometric objects, from the domain elements by geometric operators according to the domain model, wherein the 3D geometric objects maintain the semantic information of the domain elements, and the semantic information is allowed to be defined in a level of the objects.

### TECHNICAL FIELD

The present application relates generally to the technical field of visualization, and more particularly, to a method and system for generating three dimensional geometric models.

### BACKGROUND

With the development of computing capability (especially GPU and PPU are coming), the 3D-based application is becoming more prevalent because of its immersion and immediacy of visualization, and is increasingly used in various domains, e.g., 3D geometric models of large buildings, campus, and industry control.

A 3D geometric model of a large building, for example, can be used to enhance situation awareness, such as firefighting, building security, and HVAC (heating, ventilation, and air conditioning) management. Additionally, a 3D geometric model of a campus, for example, can present firefighters with an intuitive picture about the surroundings of a building on fire, and help the firefighters find a route on the campus to access the building on fire. Furthermore, a 3D geometric modes of industry control can intuitively show, for example, the operation state (e.g., temperate, pressure, material level) of a reactor, the flow state (e.g., flow speed, direction of a liquid) of a pipe, or the working state (e.g., open or close) of a pump/valve.

However, it is a challenging task to efficiently create a 3D geometric model for a domain and to effectively support the interactions between users and the 3D geometric model at runtime.

### BRIEF DESCRIPTION OF THE DRAWINGS

Some embodiments are illustrated by way of examples, and not by way of limitations, in the figures of the accompanying drawings in which:

FIG. 1 is a block diagram illustrating an exemplary 3D geometric modeling system according to an example embodiment;

FIG. 2 is a table illustrating an exemplary geometric element library according to an example embodiment;

FIG. 3 is a table illustrating an exemplary geometric operator library according to an example embodiment;

FIG. 4 is a table illustrating exemplary rules for identifying domain elements according to an example embodiment;

FIG. 5 is a table illustrating exemplary rules for generating 3D geometric model from the domain elements according to an example embodiment;

FIG. 6 is a flowchart illustrating an example method for generating a 3D geometric model of a domain according to an example embodiment;

FIGS. 7A-7F are diagrams illustrating an example of generating a 3D geometric model of a story within a building from a file according to an example embodiment;

FIGS. 8A-8C are diagrams illustrating an example of generating a 3D geometric model of a campus from a map according to an example embodiment;

FIGS. 9A-9B are diagrams illustrating an example of generating a 3D geometric model of a factory from a sketch-based factory layout according to an example embodiment; and

FIG. 10 is a block diagram illustrating an exemplary machine in the form of a computer system, within which a set of sequence of instructions for causing the machine to perform any one of the methodologies discussed herein may be executed.

### DETAILED DESCRIPTION

In the following description, for purposes of explanation, numerous specific details are set forth in order to provide a thorough understanding of example embodiments. It will be evident, however, to one skilled in the art that the embodiments of the application may be practiced without these specific details.

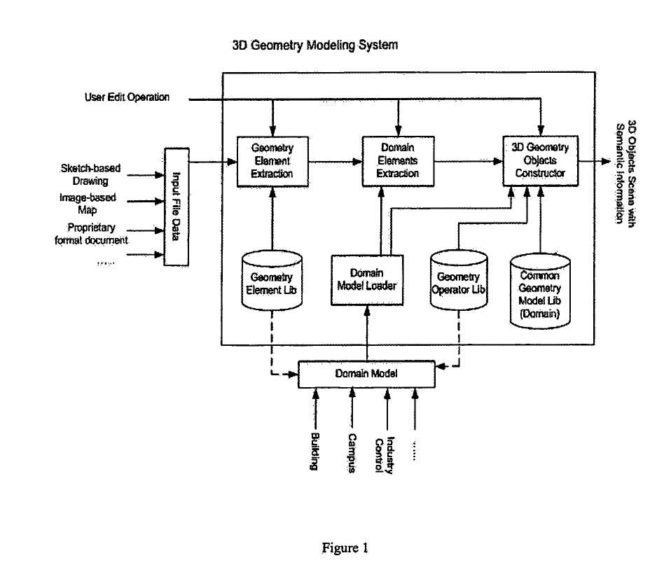

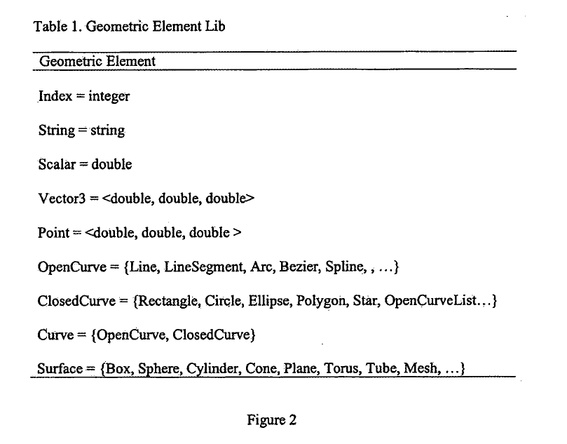

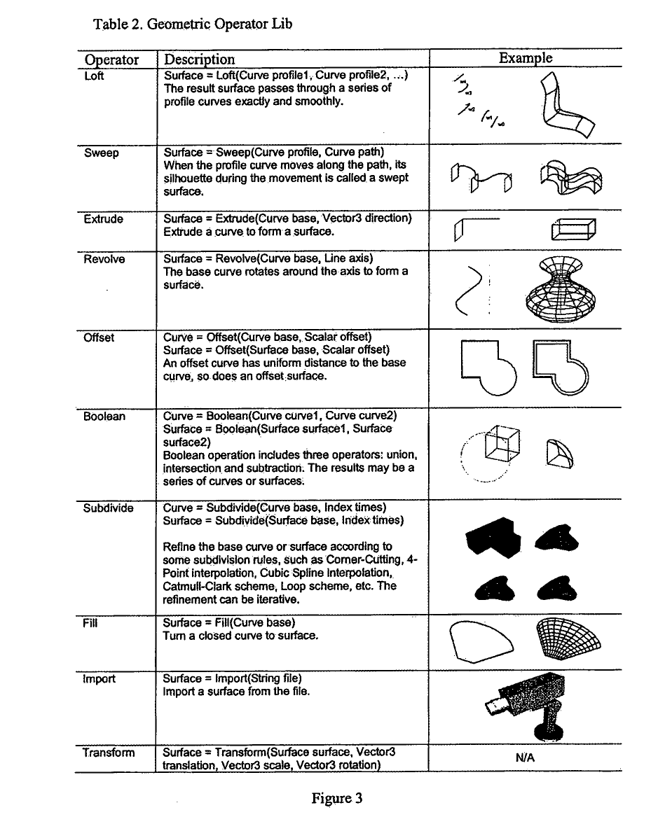

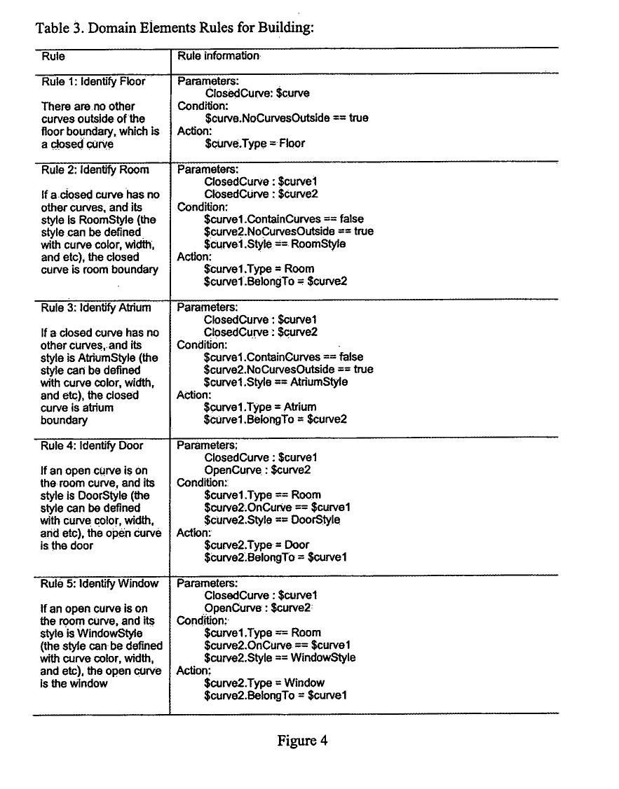

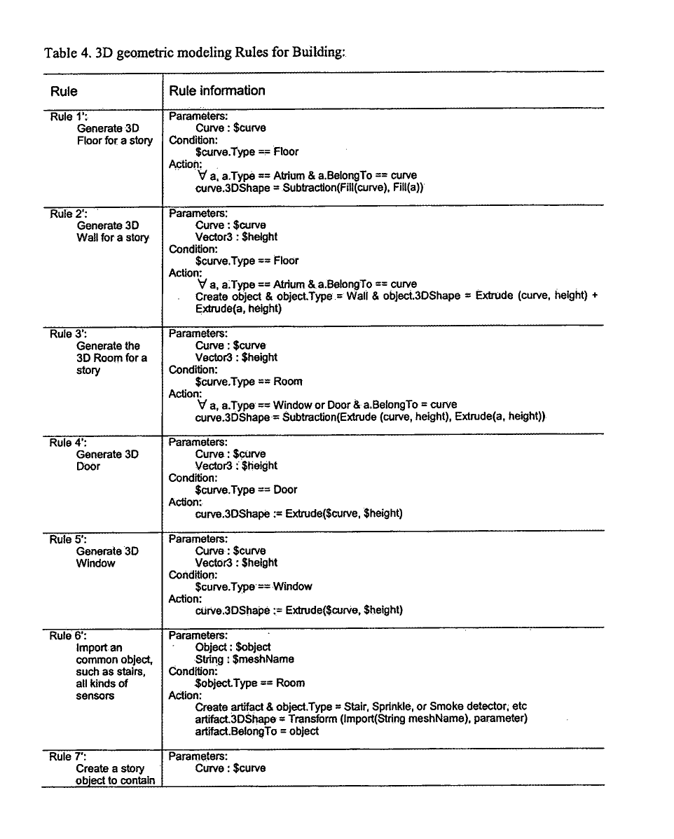

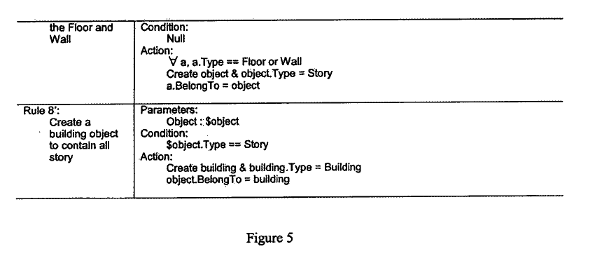

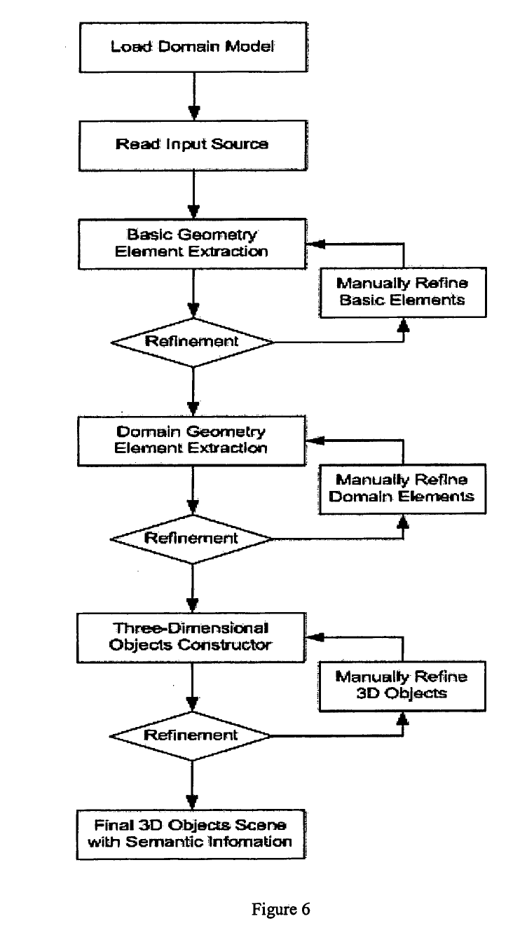

The present application describes a model-driven 3D geometric modeling system and method (as shown in FIGS. 1 and 6), which abstract the basic geometric elements and basic geometric operators (as shown respectively in FIGS. 2 and 3). For each different domain, a domain model (as shown in FIG. 1) is defined and built by domain experts based on the basic geometric elements and basic geometric operators. Each domain corresponds to a different type or field, for example, large buildings, campus, or industry control. Different domain may have different domain elements. For example, the domain of large buildings may have domain elements such as stories, floors, rooms, atriums, doors, windows, walls, stairs, sensors, and etc. The domain of campus may have domain elements such as buildings, streets, roads, squares, greenbelts and etc. The domain of industry control may have domain elements such as reactors, pipes, valves, pumps, splitters, and etc. The domain model of a domain describes rules for identifying domain elements (as shown in FIG. 4) and rules for generating a 3D geometric model from these domain elements (as shown in FIG. 5) for the specific domain.

For example, in order to generate a 3D geometric model for a domain, first, the basic geometric elements can be extracted from an input source (e.g., sketch-based drawing, image-based map) with known geometric computation technology, digital image processing technology, and pattern recognition technology. Then, the basic geometric elements can be converted into domain elements according to the rules for identifying domain elements, which have been described in the domain model (as shown in FIG. 4). After that, geometric operators can be used to construct the 3D geometric model of the specific domain from the domain elements according to the rules for generating a 3D geometric model (as shown in FIG. 5). The 3D geometric model may include many 3D geometric objects.

The semantic information of the domain elements, for example, types or classifications (e.g., rooms, doors, windows) to which the domain elements belong, and relationships among the domain elements objects, have been defined in the domain model. Thus, the semantic information is preserved in the domain elements. Accordingly, the constructed objects included in the 3D geometric model also maintain such semantic information. By virtue of the semantic information maintained in the objects of the 3D geometric model, users of the present application can easily navigate, visualize, or interact with the whole 3D geometric model.

Additionally, in order to obtain a high quality 3D geometric model, at different stages, the users of the present application are permitted to refine, e.g., the geometric elements, the domain elements, and/or the 3D geometric objects by e.g., adding, deleting or modifying these elements or objects, and thus may modify or update the semantic information of the 3D geometric model at different stages.

FIG. 1 is a block diagram illustrating an exemplary 3D geometric modeling system 100 according to an example embodiment. In some embodiments, the 3D geometric modeling system 100 for generating a 3D geometric model of a domain may include: an input source 10, a geometric element extractor 20, a domain element extractor 30, a 3D geometric object constructor 40, a geometric element library 50, a geometric operator library 60, a domain model 70 for the domain, a domain model loader 80 to load the domain model 70, and a common geometric model library 90.

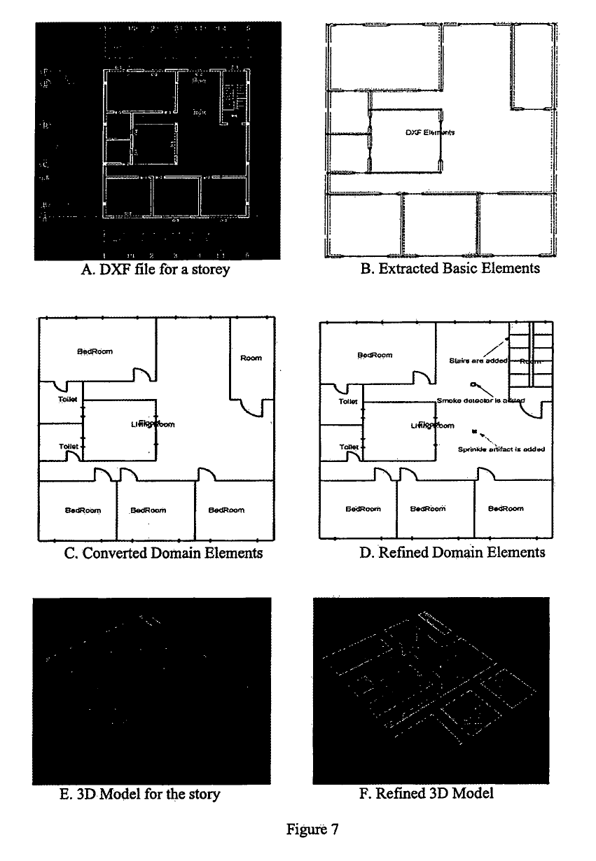

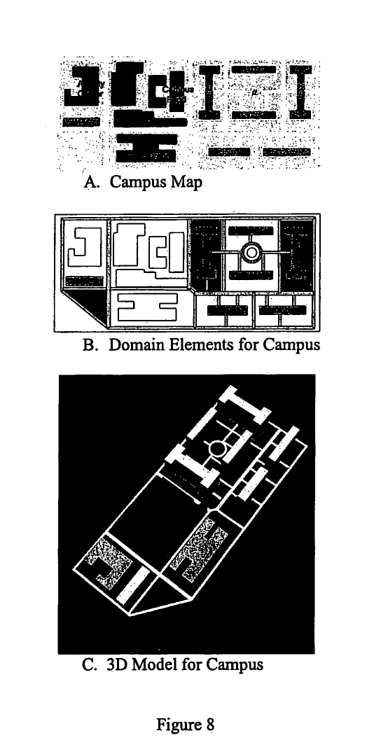

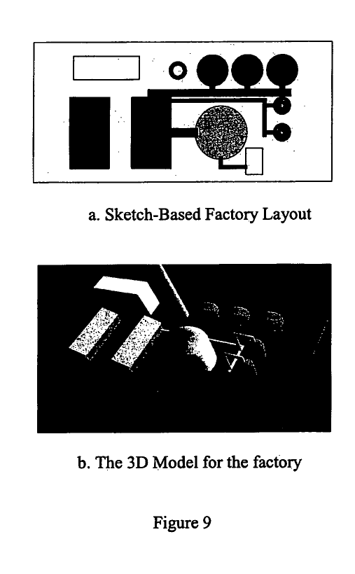

The input source 10 of FIG. 1 can take a variety of forms, for example, a JPEG (Joint Photographic Experts Group) file, a SVG (Scalable Vector Graphics) file, a DXF (Drawing Exchange Format) file as shown in FIG. 7A, an image-based campus map as shown in FIG. 8A, and a sketched-based factory layout as shown in FIG. 9A, and etc.

The geometric element extractor 20 of FIG. 1 is a module, which can be used to extract basic geometric elements, such as open curve, closed curve, surface, etc, from the input source 10 with for example digital image processing technology, geometric computation technology, and pattern recognition technology. These basic geometric elements are defined in the geometric element library as shown in FIG. 2.

The domain element extractor 30 of FIG. 1 is a module, which can be used to convert the basic geometric elements into domain elements (for example, floor, room, atrium, door, window, and etc) according to the domain model 70 of the domain using the rules for identifying domain elements as shown in FIG. 4. The domain elements may preserve semantic information of their attributes and relationships defined in the domain model 80. The attributes of the domain elements include classification, geometric, and material characteristics thereof. The relationships of the domain elements include spatial and hierarchical relationships thereof.

The 3D geometric model constructor 40 of FIG. 1 is a module, which can be used to construct a 3D geometric model (including objects) of the domain by basic geometric operators (included in the geometric operator library of FIG. 3) according to the domain model 80. The 3D geometric objects may inherit the semantic information of their corresponding domain elements, and thus include classification, geometric, and material information, and spatial and hierarchical relationship information of the corresponding domain elements. The users are allowed to define, or refine (e.g., modifying, adding) the semantic information of the domain elements and/or the 3D geometric objects at different stages (e.g., after extracting the domain elements, after constructing the 3D geometric objects). With the attributes and relationship of the 3D geometric objects of the example embodiment, the users of the 3D geometric model can easily interact with the 3D geometric model at runtime. The exemplary system can, for example, distinctively display a selected floor with sufficient details in the 3D building model with the hierarchical relationship among floor, room, door, window, sensor, and etc. The system can, for example, effectively help retrieve optimal route to a spot at runtime using the spatial attributes of the 3D geometric objects. By the semantic information, the system can also, for example, display (or highlight) some types of objects and hide some types of object so as to emphasize the displayed objects.

The geometric element library 50 of FIG. 1 (as shown in detail in FIG. 2) and the geometric operator library 60 (as shown in detail in FIG. 3) can be used to define the domain model 80. The common geometric model library 90 can be used to define some common 3D models, which are intended to be shared in the domain.

FIG. 2 is a table (Table 1) illustrating an exemplary geometric element library according to an example embodiment. FIG. 2 gives an example of Geometric Element Lib, which defines for example point, open curve, closed curve, curve, surface, and etc.

FIG. 3 is a table (Table 2) illustrating an exemplary geometric operator library according to an example embodiment. FIG. 3 gives an example of Geometric Operator Lib, which defines geometric operators, for example, loft, sweep, revolve, offset, Boolean, subdivide, fill, import, transform, and etc. The geometric element library and geometric operator library play important roles in the system.

FIG. 4 is a table (Table 3) illustrating exemplary rules for identifying domain elements according to an example embodiment. These rules for identifying domain elements not only designate the geometric features (e.g., position, shape, and etc) for each domain element, but also designate the relationship among the domain elements (e.g., which room does a door or a window belong to, or which floor does a room belong to). The geometric features can be used to furthermore deduce spatial relationship (e.g., which rooms is a room adjacent to). With these rules for identifying domain elements, the domain element extractor 30 as shown in FIG. 1 will automatically recognize the floor, room, door and window etc.

FIG. 5 is a table (Table 4) illustrating exemplary rules for generating 3D geometric model from the domain elements according to an example embodiment. Once obtaining some basic domain elements (e.g., rooms, windows, doors, and etc), more other domain elements (e.g., stairs, sensors, artifacts, and etc) can be further defined. With these rules generating 3D geometric model, the 3D geometric object constructor 40 as shown in FIG. 1 can automatically convert these domain elements into 3D geometric objects.

For a specific domain, the input file format may be various. Most parts of the domain model can be reused among different inputs, and only minor revision is needed. For example, for the building domain, the floor plan may be shown by an image of the format of, for example, JPEG format rather than DXF. In this case, the domain elements are recognized according to their appearance or structure by pattern recognition technology (e.g., symbols [symbol] and [symbol] are respectively recognized as doors, elevators, and stairs). With the domain elements, the 3D geometric process with geometric operators is similar.

Different domains have different domain models, which will be formalized respectively. For example, for the domain of campus, the domain elements, which will be extracted and be 3D modeled, include streets, roads, squares, greenbelts, buildings and etc. However, for the domain of industry control, the domain elements, which will be extracted and be 3D modeled, include reactors, pipes, pumps, valves, splitters, and etc.

FIG. 6 is a flowchart illustrating an example method for generating a 3D geometric model of a domain according to an example embodiment.

At 602, loading a domain model of the domain. The domain model is defined by domain experts based on a geometric element library and a geometric operator library.

At 604, reading an input source. The input source can take a variety of forms, for example, a JPEG file, a SVG file, a DXF file, and etc. The input source can be, for example, a scanned floor blueprint, an image-based campus map, a sketched-based factory layout, and etc. FIG. 7A shows a DXF file, which is used as the input source for a story. FIG. 8A shows a campus map image, which is used as the input source for a campus.

At 606, extracting basic geometric elements from the input source by using digital image processing technology, geometric computation technology, pattern recognition technology, and etc. FIG. 7B shows the basic geometric elements of a story extracted from the input source (the DXF file).

At 608, if a developer is not satisfied with the extracted basic geometric elements, the developer can manually define or refine these basic geometric elements at 610. The developer can repeat this refinement process until he is satisfied with these basic geometric elements.

At 612, converting the basic geometric elements into domain elements according to a domain model, in which the domain elements preserve their semantic information of attributes and relationships defined in the domain model. In one example embodiment, the domain elements are recognized from the basic geometric elements according to the domain model with rule-based reasoning mechanism. FIG. 7C shows domain elements of a story within a building. FIG. 8B shows domain elements of a campus, which are converted from basic geometric elements with image processing and pattern recognition technology. FIG. 9A shows domain elements of a factory.

At 614, if a developer is not satisfied with the converted domain elements, the developer can manually define or refine these domain elements at 616, for example, by adding, deleting, or modifying domain elements. FIG. 7D shows how to add stairs and sensors to the converted domain elements of the story. The developer can choose to repeat this refinement process until he is satisfied with these domain elements.

At 618, constructing a 3D geometric model, including 3D geometric objects, from the domain elements by geometric operators according to the loaded domain model, in which the 3D geometric objects maintain the semantic information of the domain elements. FIG. 7E shows the rendered 3D geometric model of a story in a building. FIG. 8C is the rendered 3D geometric model of a campus. FIG. 9B is the rendered 3D geometric model of a factory.

At 620, if a developer is not satisfied with the constructed 3D geometric model, the developer can manually define or refine one or more 3D geometric objects at 622, for example, by adding, deleting, or modifying features of the 3D geometric objects. FIG. 7F shows the refined 3D geometric model by adding texture and material features to some constructed 3D geometric objects as shown in FIG. 7E.

At 624, outputting the final 3D geometric model with the semantic information, with which the end user can easily navigate or manipulate the objects of the 3D geometric model in real application.

The application provides examples to show how to generate different 3D geometric models of different domains. FIGS. 7A-7F show an example of generating a 3D geometric model of a story of a building from a DXF file. FIGS. 8A-8C show another example of generating a 3D geometric model of a campus from a map. FIGS. 9A-9B show still another example of generating a 3D geometric model of a factory from a sketch-based factory layout.

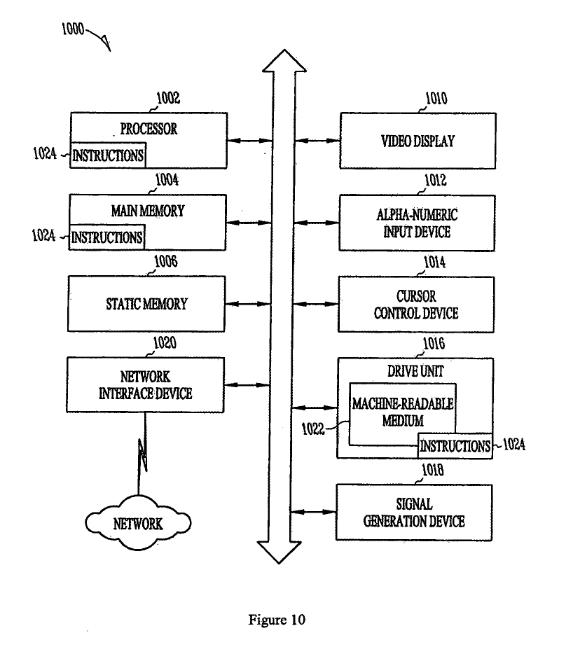

FIG. 10 is a block diagram illustrating an exemplary machine in the form of a computer system, within which a set of sequence of instructions for causing the machine to perform any one of the methodologies discussed herein may be executed. In some embodiments, the machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions that specify actions to be taken by that machine. Further, while only a single machine is illustrated, the term “machine” shall also be taken to include any collection of machines that individually or jointly execute a set of instructions to perform any one or more of the methodologies discussed herein.

The example computer system 1000 includes a processor 1002 (e.g., a central processing unit (CPU) a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a cursor control device 1014 (e.g., a mouse), a disk drive unit 1016, a signal generation device 1018 (e.g., a speaker) and a network interface device 1020.

The disk drive unit 1016 includes a machine-readable medium 1022 on which is stored one or more sets of instructions (e.g., software 1024) embodying any one or more of the methodologies or functions described herein. The software 1024 may also reside, completely or at least partially, within the main memory 1004 and/or within the processor 1002 during execution thereof by the computer system 1000, the main memory 1004 and the processor 1002 also constituting machine-readable media.

The software 1024 may further be transmitted or received over a network 1026 via the network interface device 1020.

While the machine-readable medium 1022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and electromagnetic signals.

The above-described steps can be implemented using standard programming techniques. The novelty of the above-described embodiment lies not in the specific programming techniques but in the use of the methods described to achieve the described results. Software programming code which embodies the present application is typically stored in permanent storage. In a client/server environment, such software programming code may be stored in storage associated with a server. The software programming code may be embodied on any of a variety of known media for use with a data processing system, such as a diskette, or hard drive, or CD ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

While there has been described herein the principles of the application, it is to be understood by those skilled in the art that this description is made only by way of example and not as a limitation to the scope of the application. Accordingly, it is intended by the appended claims, to cover all modifications of the application which fall within the true spirit and scope of the application.

1. A method of generating a 3D geometric object model for a domain, comprising:
extracting basic geometric elements from an input source;
converting the basic geometric elements into domain elements according to a domain model, wherein the domain elements preserve their semantic information on attributes and relationships defined by the domain model; and
constructing a 3D geometric model, including 3D geometric objects, from the domain elements by geometric operators according to the domain model,
wherein the 3D geometric objects maintain the semantic information of the domain elements, and the semantic information is allowed to be refined in a level of the objects.

2. The method of claim 1, further comprising:
loading the domain model of the domain.

3. The method of claim 1, further comprising:
outputting the 3D geometric model with the semantic information.

4. The method of claim 1, wherein the domain model is defined based on a geometric element library and a geometric operator library.

5. The method of claim 1, further comprising:
refining at least one of the extracted basic geometric elements.

6. The method of claim 1, further comprising:
refining at least one of the extracted basic geometric elements.

7. The method of claim 1, further comprising:
refining at least one of the 3D geometric objects of the constructed 3D geometric model, during which additional semantic information is allowed to be added thereto.

8. The method of claim 1, wherein the attributes of the domain elements include classification, geometric, and material characteristics thereof, the geometric characteristics of the domain elements indicate position and shape thereof.

9. The method of claim 1, wherein the relationships of the domain elements include spatial relationships thereof.

10. The method of claim 1, wherein the relationships of the domain elements include hierarchical relationships thereof.

11. A system for generating a 3D geometric model of a domain, comprising:
a geometric element extractor to extract basic geometric elements from an input source;
a domain element extractor to convert the basic geometric elements into domain elements according to a domain model of the domain, wherein the domain elements preserve semantic information of their attributes and relationships defined in the domain model; and
a 3D geometric object constructor to construct a 3D geometric model, including 3D geometric objects, from the domain elements by basic geometric operators according to the domain model, wherein the semantic information is allowed to be refined on an object level.

12. The system of claim 11, further comprising:
a geometric element library and a geometric operator library, from which the domain model is defined; and
a domain model loader to load the domain model.

13. The system of claim 11, further comprising:
a common geometric model library to define common 3D models to be shared in the domain.

14. The system of claim 11, further comprising:
an output device to export the constructed 3D geometric model with the semantic information.

15. The system of claim 11, wherein the attributes of the domain elements include classification, geometric, and material characteristics thereof.

16. The system of claim 11, wherein the relationships of the domain elements include spatial and hierarchical relationships thereof

17. A computer-readable medium including instructions that, performed by a computer in a system, cause the computer to:
load a domain model for the domain;
read an input source;
extract basic geometric elements from the input source;
convert the basic geometric elements into domain elements according to the loaded domain model, wherein the domain elements preserve semantic information on geometric attributes and relationships thereof; and
construct a 3D geometric model from the domain elements, according to the loaded domain model, by geometric operators included in a geometric operator library, wherein the 3D geometric model includes 3D geometric objects with the semantic information.

18. The computer-readable medium of claim 17, further comprising instructions that cause the computer to:
output the 3D geometric model with the semantic information.

19. The computer-readable medium of claim 17, wherein the attributes of the domain elements include classification, geometric, and material characteristics thereof

20. The computer-readable medium of claim 17, wherein the relationships of the domain elements include spatial and hierarchical relationships thereof.
